(19) United States
(12) Patent Application Publication
(10) Pub. No.: US 2004/0038054 A1
(43) Pub. Date: Feb. 26, 2004

(54) Laminate for substrate of printed wiring board

(76) Inventors: Hongyuan Wang, Chiba (JP); Yoshiko Abe, Chiba (JP); Katsufumi Hiraishi, Chiba (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/642,136

(22) Filed: Aug. 18, 2003

(30) Foreign Application Priority Data
Aug. 20, 2002 (JP) 238945/2002

(51) Int. Cl. B32B 27/00

(52) U.S. Cl. 428/473.5

(57) ABSTRACT

This invention relates to a laminate for a substrate of printed wiring board containing an insulating polyimide resin layer processible by wet etching with an aqueous solution of an alkali metal hydroxide. This laminate has a metal foil on one or both sides of the polyimide resin layer and at least one layer of the polyimide resin layer contains 5 mol % or more of a structural unit of trimellitic anhydride ester acid dianhydride having a segment derived from trimellitic acid anhydride and a segment derived from a bisphenol and shows a rate of etching of 2.0 μm/min or more by a 30 wt % aqueous solution of potassium hydroxide kept at 80° C. to which 11 wt % of ethylenediamine and 22 wt % of ethylene glycol are added.

### TECHNICAL FIELD

This invention relates to laminates for substrates of printed wiring boards. The laminates in question are processed by wet etching into substrates of flexible printed wiring boards and HDD suspensions.

### BACKGROUND TECHNOLOGY

Laminates to be used in the substrates of printed circuits and HDD suspensions have been manufactured by pasting polyimide or polyester films to metal foils by means of an adhesive based on epoxy or acrylic resin. However, laminates manufactured in this manner show poor heat resistance because of the presence of an adhesive layer and, when subjected to a heat treatment, undergo dimensional changes to such an extent as to hinder the following steps.

To solve this problem, laminates composed of metal foils and polyimide resins exhibiting good adhesiveness to metal foils and high heat resistance have been devised as disclosed in JP 5-22399 B. However, laminates composed of those polyimide resins which possess the aforementioned properties are generally processed by dry etching by the ultraviolet laser or plasma process and this practice has causes problems such as costly equipment, high running cost including the cost of gases to be used and poor quality for mass production.

Under the circumstances, materials processible by wet etching with organic alkalis or aqueous solutions of inorganic alkalis as etchants have been in demand as substitutes for materials processible by the aforementioned dry etching. However, the use of organic alkalis such as hydrazine presents a problem of high toxicity. Typical materials processible by wet etching with an aqueous alkaline solution are polyimide resins Kapton® of duPont and Apical® of Kaneka Corporation and the processing technique proposed for these polyimide resins consists of directly plating the resins with metals and etching the plated resins in an arbitrary shape. This technique, however, faces problems such as an increased number of processing steps and poor dimensional accuracy and is further restricted by the characteristics of metals in use.

On the other hand, a proposal is made in JP6-322129A for laminates which comprise specific polyimide resins prepared by using pyromellitic dianhydride as an aromatic acid dianhydride constituting polyimide and are processible by wet etching with an aqueous alkaline solution. It is pointed out, however, that the use of pyromellitic dianhydride alone as an acid dianhydride yields polyimide resins that exhibit large water absorption and find limited uses.

Furthermore, novel polyimides having specific structural units for improved heat resistance, thermoplasticity and adhesiveness and reduced water absorption are proposed in JP7-3019A and films of polyimides prepared by the use of a variety of acid anhydrides including aromatic diester acid dianhydrides are proposed in JP10-36506A and JP2000-159887A. However, the object of JP10-36506A is to provide polyimide compositions and polyimide films of low thermal expansion, low water absorption and low moisture expansion while the object of JP2000-159887A is to manufacture polyimide films of high elasticity, high storage elastic modulus, low coefficient of linear thermal expansion and low coefficient of moisture expansion and both inventions do not teach polyimides useful for processing by wet etching.

### SUMMARY OF THE INVENTION

An object of this invention is to provide a laminate for a substrate of printed wiring board characterized by having an insulating resin layer which comprises polyimide resin of excellent processibility by wet etching with an aqueous alkaline solution.

The aforementioned object was attained by providing a layer of polyimide resin that has a specified structure and shows a rate of etching higher than a specified value in a laminate for a substrate of printed wiring board.

In the laminate of this invention which comprises a polyimide resin layer and a metal foil on one or both sides of the polyimide resin layer and is processible by wet etching, at least one layer of the polyimide resin layer contains 5 mol % or more of a structural unit represented by the following general formula (1)

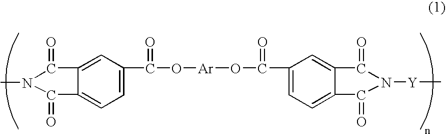

(wherein Ar is a divalent organic group having one or more aromatic rings, Y is a divalent group remaining after removal of two amino groups from a diamine and n is a number in the range of 1˜1000) and shows a rate of etching of 2.0 μm/min or more by a 30 wt % aqueous solution of potassium hydroxide kept at 80° C. to which 11 wt % of ethylenediamine and 22 wt % of ethylene glycol are added.

The polyimide resin layer here comprises polyimide resin obtained by the reaction of a diamine with a tetracarboxylic acid dianhydride and, preferably, 50 mol % or more of the aforementioned tetracarboxylic acid dianhydride is a trimellitc anhydride ester tetracarboxylic acid dianhydride represented by the following general formula (2)

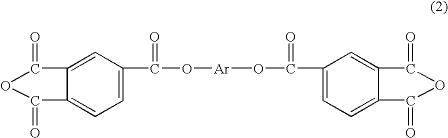

(wherein Ar is a divalent organic group containing one or more aromatic rings) or a combination of the trimellitic anhydride ester tetracarboxylic acid dianhydride and at least one kind of tetracarboxylic acid dianhydride selected from pyromellitic dianhydride, 3,3′,4,4′-benzophenonetetracarboxylic acid dianhydride and 3,3′,4,4′-diphenylsulfonetetracarboxylic acid dianhydride.

### DETAILED DESCRIPTION OF THE INVENTION

The laminate of this invention for a substrate of printed wiring board (hereinafter also referred to as laminate of this invention) has a metal foil on one or both sides of the polyimide resin layer.

The foils of metals used in the laminates of this invention include those of copper, aluminum, stainless steel, iron, silver, palladium, nickel, chromium, molybdenum, tungsten and alloys of these metals. Copper is cited as a material suitable for use in the substrates of flexible printed circuits. Copper and stainless steel are cited as materials suitable for use in load beams and flexures of HDD suspensions. In the cases where a laminate has metal foils on both sides or has two layers or more of metal foils, it is possible to vary the kind and thickness of metal foil from layer to layer.

Although there is no specific restriction on the thickness of a metal foil, the thickness of those metal foils which are used in flexible printed circuits and HDD suspensions is 3-300 μm, preferably 10-100 μm. It is allowable to apply a chemical or mechanical surface treatment to these conductors for the purpose of increasing the bonding strength still further.

In the laminate of this invention, the resin layer in contact with the metal foil is composed of a single layer of polyimide resin or plural layers of polyimide resins. The single layer itself in the case of a single layer structure or at least one layer in the case of a multilayer structure contains 5 mol % or more of the structural unit represented by general formula (1) and the layer in question shows a rate of etching of 2.0 μm/min or more at 80° C. by an aqueous solution in which 11 wt % of ethylenediamine, 22 wt % of ethylene glycol and 30 wt % of potassium hydroxide are dissolved.

The aqueous solution in which 11 wt % of ethylenediamine, 22 wt % of ethylene glycol and 30 wt % of potassium hydroxide are dissolved is hereinafter also referred to as an aqueous alkaline solution for evaluation use. Moreover, the polyimide resin layer containing 5 mol % or more of the structural unit represented by general formula (1) and showing a rate of etching of 2.0 μm/min or more at 80° C. by an aqueous solution in which 11 wt % of ethylenediamine, 22 wt % of ethylene glycol and 30 wt % of potassium hydroxide are dissolved is also referred to as polyimide resin layer A.

The term of polyimide resin as used in this invention refers to a resin containing imide groups in its structure such as polyimide, polyamideimide, polyetherimide, polysiloxaneimide and polybenzimidazoleimide. Polyimide resin can be prepared by a publicly known method. For example, a tetracarboxylic acid dianhydride and a diamine, roughly in equimolar amounts, are allowed to react in a solvent in the range of 0-200° C., preferably in the range of 0-100° C., to give a solution of the precursor of polyimide resin and the precursor is imidized to polyimide.

The polyimide resins constituting the polyimide resin layer A can be prepared from diamines that are normally used as raw materials for polyimide resins. Diamines particularly suitable for the preparation of polyimide resins processible by wet etching include p-phenylenediamine, m-phenylenediamine, 2,4-diaminotoluene, 1,3-bis(3-aminophenoxy)benzene, 3,4′-diaminodiphenyl ether, 4,4′-diamino-2′-methoxybenzanilide, 4,4′-diamino-2,2′-dimethylbiphenyl and 4,4′-diaminodiphenyl ether.

It is also allowable to use the aforementioned diamines in combination with other diamines such as 2,2′-bis[4-(4-aminophenoxy)phenyl]propane, 4,4′-bis(3-aminophenoxy)biphenyl, 4,4′-diaminodiphenylpropane, 3,3′-diaminobenzophenone and 4,4′-diaminodiphenyl sulfide. However, the proportion of these other diamines is kept below 30 mol %, preferably below 20 mol %. In particular, addition of 2,2′-bis[4-(4-aminophenoxy)phenyl]propane or 4,4′-bis(3-aminophenoxy)biphenyl is preferably kept below 10 mol % because even a small addition of either of the two deteriorates markedly the performance of the product polyimide in etching by an aqueous alkaline solution.

As for tetracarboxylic acid dianhydrides, it is necessary to use a trimellitic anhydride ester tetracarboxylic acid dianhydride (hereinafter also referred to as TMTCDA) represented by general formula (2) as an essential component and this acid dianhydride is used at a rate of 5 mol % or more, preferably 10 mol % or more, more preferably 30 mol % or more, of the total tetracarboxylic acid dianhydrides. The group Ar in general formula (2) is a divalent organic group having one or more aromatic rings and preferred as such are the groups represented by the following formulas (3) to (5), wherein R1 through R3, R6 and R7 denote an alkyl group containing 1-3 carbon atoms, vinyl group or hydrogen and R4 and R5 denote an alkyl group containing 1-3 carbon atoms, phenyl group or hydrogen.

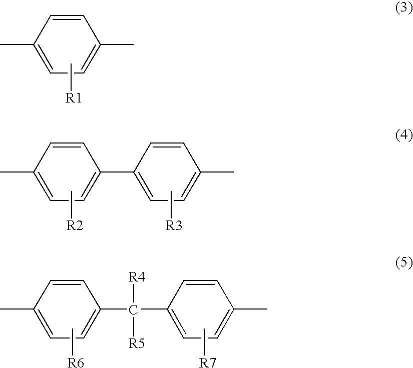

TMTCDA may be used either singly or together with one kind or two kinds or more of acid dianhydrides selected from pyromellitic dianhydride (PMDA), 3,3′,4,4′-benzophenonetetracarboxylic acid dianhydride (BTDA) and 3,3′,4,4′-diphenylsulfonetetracarboxylic acid dianhydride (DSDA). Furthermore, other tetracarboxylic acid dianhydrides can also be used; however, it is to be noted that other acid dianhydrides such as 3,3′,4,4′-biphenyltetracarboxylic acid dianhydride (BPDA) and 4,4′-oxydiphthalic acid dianhydride (ODPA) are preferably used at a rate of 40 mol % or less, preferably 20 mol % or less, of the total tetracarboxylic acid dianhydrides because their addition is effective for reducing moisture absorption of the product polyimide on the one hand and markedly deteriorates the performance of the product polyimide in etching by an aqueous alkaline solution on the other.

The aforementioned other tetracarboxylic acid dianhydrides are kept below 30 mol %, preferably below 10 mol %, of the total tetracarboxylic acid dianhydrides. The use of 50 mol % or more, preferably 80 mol % or more, of TMTCDA, PMDA, BTDA and DSDA can also provide the product polyimide with good performance in etching. It is advantageous to control the amount of PMDA in the range of 5-60 mol % and the sum total of TMTCDA, BTDA and DSDA in the range of 20-95 mol %.

Solvents useful for the synthesis of polyimide resins include N-methylpyrrolidone (NMP), dimethylformamide (DMF), dimethylacetamide (DMAc), dimethyl sulfoxide (DMSO), dimethyl sulfate, sulfolane, butyrolactone, cresol, phenol, halogenated phenol, cyclohexane, dioxane, tetrahydrofuran, diglyme and triglyme.

In case the polyimide resin layer has a multilayer structure, other polyimide resin layers may exist in addition to the polyimide resin layer A. Such other polyimide resin layers are not restricted in any way except they must be processible by wet etching and polyimide resins prepared from known diamines and tetracarboxylic acid dianhydrides can be used as such. Polyimide resins whose rate of etching as defined earlier is 0.5 μm/min or more are preferable and, furthermore, it is desirable to let the polyimide resin layer as a whole show a rate of etching of 2 μm/min or more. The performance in etching improves further if the whole polyimide resin layers fall in the scope of the polyimide resin layer A.

The laminate of this invention is characterized by that the polyimide resin layer in the laminate shows a good performance in etching by an aqueous alkaline solution. At least one of the polyimide resin layers consists of the polyimide resin layer A which needs to show a rate of etching at 80° C. of 2.0 μm/min or more, preferably 4.0 μm/min or more, more preferably 8.0 μm/min or more, when tested by the aqueous alkaline solution for evaluation use. The upper limit of the rate of etching is 30 μm/min or less, preferably 20 μm/min or less.

In case the polyimide resin layer has a multilayer structure, it is desirable that the rate of etching expressed by the value obtained by dividing the total thickness (μm) of the polyimide resin layers by the time required for etching (min) satisfies the aforementioned rate of etching. In the case of a multilayer structure, it is further desirable that all the polyimide resin layers satisfy this rate of etching. Various problems arise when the rate of etching falls short of 2.0 μm/min; for example, a good etching shape is not obtained, the resistance of a resist to an aqueous alkaline solution is not obtained, fine processing is not possible and the production efficiency drops.

Furthermore, in the case of a multilayer structure, it is preferable to let the polyimide resin layers as a whole contain 5 mol % or more of the structural unit represented by general formula (1) and show the aforementioned rate of etching of 2.0 μm/min or more.

The thickness of the polyimide resin layer is preferably in the range of 3-75 μm, more preferably in the range of 3-50 μm. When the thickness is exceeds this range, a slope is formed in the etched thereby developing the possibility of making fine processing by etching difficult and, in addition, the drying efficiency drops in the steps involving application and drying of a solution of polyimide resin. The thickness of the laminate as a whole is preferably in the range of 20-350 μm.

The bonding strength between polyimide resin layer and metal foil in the laminate of this invention is preferably 0.5 kN/m or more, more preferably 1.0 kN/m or more. The bonding strength here is expressed by the numerical value of the 180° peel strength at room temperature. When the bonding strength is short of 0.5 kN/m, the metal foil undesirably comes off in the later steps.

The laminate of this invention can be manufactured by a variety of methods. For example, a coating method is applied in the following manner; a solution of a polyimide precursor resin which is to form a polyimide resin layer is applied to the surface of a metal foil such as copper foil, the solvent remaining in the solution is dried off and the polyimide precursor resin is imidized by heating at a temperature above 200° C., preferably above 300° C., to give a laminate in which a polyimide resin layer is formed on the metal foil. In case a multilayer structure is desired, one of the methods useful for the purpose consists of repeating the aforementioned procedure for forming a polyimide layer and another method consists of applying a solution of a polyimide precursor resin to a metal foil followed by drying, repeating this to build a multilayer structure and imidizing the plural layers of the polyimide precursor together. In the case of a multilayer structure such as this, the polyimide resin layer A is used to constitute at least one of the plural layers. The total thickness of the polyimide resin layers is controlled in such a manner as to obtain a thickness in the range of 3-75 μm after drying and curing.

In the cases where a laminate having metal foils on both sides of a polyimide resin layer is desired, a laminate having a metal foil on one side is first prepared by the aforementioned method and then bonded by thermocompression to another laminate having a metal foil and a polyimide resin layer to give a double-sided laminate.

The laminate of this invention can be processed into a desired pattern, for example, by forming a resist layer of a desired pattern on the metal foil, etching the metal foil with the resist layer used as a mask, removing the resist layer and etching the polyimide resin layer at 50° C. or above by the use of a 5-80 wt % aqueous solution of at least one kind of alkali metal hydroxide.

Also the laminate of this invention is further processed preferably by etching the metal foil in a specified pattern, forming a resist layer of a specified pattern on the surface including the portion of the insulating resin layer which should not be processed by etching, and etching the insulating resin layer at 50° C. or above by an aqueous alkaline solution or a mixture thereof in a specified pattern.

An etching solution suitable for etching of the polyimide layer preferably has a pH in the range of 11-14. An alkaline solution containing an alkali metal hydroxide such as potassium hydroxide, sodium hydroxide and lithium hydroxide and a primary or secondary aliphatic amine such as ethylenediamine and diethylamine as essential components is suitable as an etching solution of the aforementioned type. In particular, an aqueous alkaline solution containing 10-50 wt % of an alkali metal hydroxide, 8-70 wt % of an aliphatic amine and 10-40 wt % of an aliphatic alcohol is preferred. One kind only or a mixture of two kinds or more may be used for each of the alkali metal hydroxide, aliphatic amine and aliphatic alcohol.

In wet etching of the polyimide resin layer, the temperature of the etching solution is in the range of 30-90° C., preferably in the range of 50-85° C. In the case such as this, it is preferable to maintain the temperature of the solution at a given level by a device such as a constant temperature bath.

A method for fabricating a substrate of printed wiring board by the use of the laminate of this invention preferably comprises the following steps;

a) a step for preparing the laminate of this invention,

b) a step for forming a circuit pattern on the metal foil of the aforementioned laminate,

c) a step for preparing an etching solution consisting of an aqueous alkaline solution with a pH in the range of 11-14,

d) a step for processing the polyimide resin layer of the laminate by wet etching with the aforementioned etching solution at a rate of 2.0 μm/min or more, and

e) a step for cleaning and drying the laminate processed by wet etching.

A circuit pattern can be formed on the metal foil of a substrate of printed wiring board by a method that consists of forming a resist on the surface of the metal foil in a specified pattern and etching the metal foil in conformity to the specified pattern.

The polyimide resin layer can be etched by a method that consists of etching the opened area of the polyimide resin layer with the metal foil etched in the specified pattern used as a mask. If it becomes necessary to leave a certain area of the polyimide resin layer intact in this case, a resist layer as a mask is provided on this particular area in advance to allow opening of only the specifically exposed area of the polyimide resin layer. Alternatively, the copper foil and the polyimide resin layer in the area to be opened are respectively etched by the aforementioned method, a resist of a specified pattern is provided on the remaining copper foil and the copper foil is etched.

In the case of a double-sided laminate, one or both sides of the metal foil are etched in a specified pattern and the opened area of the polyimide resin layer is etched with the remaining metal foil used as a mask. In the case of a single-sided laminate, the metal foil is etched in a specified pattern and the opened area of the polyimide resin layer is etched with the remaining metal foil used as a mask after protecting the other side of the polyimide resin layer lacking the metal foil wholly or in a specified pattern by a resin resist or the like.

The purpose for etching the polyimide resin layer is to form via holes for providing a conductive path from one conductor to another and to control the shape and thickness of the polyimide resin layer.

A method for fabricating the laminate of this invention into an HDD suspension having a copper foil on one side and a stainless steel foil on the other preferably comprises the following steps;

a) a step for etching the copper foil the first time in a specified pattern by a photoetching process or the like,

b) a step for etching the polyimide resin layer with the patterned copper foil used as a mask wherein the etching is performed by a wet process with an aqueous alkaline solution,

c) a step for etching the copper foil the second time by a photoetching process or the like to form a required circuit, and

d) a step for etching the stainless steel foil in a specified shape.

### EXAMPLES

Various properties in the examples are evaluated by the methods described below. The polyimide resins used in the test specimens are fully imidized.

The rate of etching was determined as follows: a polyimide layer was formed on a copper foil, the thickness of the polyimide layer was measured, the polyimide layer with the copper foil attached thereto was immersed at 80° C. in a 30 wt % aqueous solution of potassium hydroxide to which 11 wt % of ethylenediamine and 22 wt % of ethylene glycol had been added, the time for complete disappearance of the polyimide resin was determined and the numerical value obtained by dividing the initial thickness of the polyimide layer by the time required for etching was taken as the rate of etching. For polyimide resins requiring a long time for etching, the numerical value obtained by dividing the loss in thickness by the time required for etching to cause the loss was taken as the rate of etching. The test was performed without stirring the etching solution under the condition which does not generate a temperature distribution.

The acid anhydrides and diamines used as raw materials for the polyimide resins in the examples are shown below by the symbols. As for the compounds in the scope of TMTCDA, the group Ar in general formula (2) is also shown in parentheses.

BP-TME: 1,3-dihydro-1,3-dioxo-5-isobenzofurancarboxylic acid (1,1′-biphenyl)-4,4′-diyl ester (Ar: 4,4′-biphenylene)

PMDA: pyromellitic dianhydride

BTDA: 3,4,3′,4′-benzophenonetetracarboxylic acid dianhydride

BPAP-TME: 1,3-dihydro-1,3-dioxo-5-isobenzofurancarboxylic acid (1-phenylethylidene)-di-4,1-phenylene ester (Ar: —C₆H₄—C(C₆H₅) (CH₃)—C₆H₄—

DSDA: 3,4,3′,4′-diphenylsulfonetetracarboxylic acid dianhydride

TMHQ: 1,3-dihydro-1,3-dioxo-5-isobenzofurancarboxylic acid 1,4-phenylene ester (Ar: —C₆H₄—)

BPA-TME: 1,3-dihydro-1,3-dioxo-5-isobenzofurancarboxylic acid (1-methylethylidene)di-4,1-phenylene ester (Ar: —C₆H₄—C(CH₃)₂—C₆H₄—)

Bisc-TME: 1,3-dihydro-1,3-dioxo-5-isobenzofurancarboxylic acid (1-methylethylidene)bis(2-methyl-4,1-phenylene) ester (Ar: —C₆H₃(CH₃)—C(CH₃)₂—C₆H₃ (CH₃)—)

BPDA: 3,3′,4,4′-biphenyltetracarboxylic acid dianhydride

BPADA: 5,5′-(1-methylethylidene)bis(4,1-phenylenoxy)bis-1,3-isobenzofurandione

ODPA: oxydiphthalic acid dianhydride

TPE-Q: 1,4-bis(4-aminophenoxy)benzene

APB: 1,3-bis(3-aminophenoxy)benzene

PDA: p-phenylenediamine

TPE-R: 1,3-bis(4-aminophenoxy)benzene

DAPE: 4,4′-diaminodiphenyl ether

DANPG: 1,3-bis(4-aminophenoxy)-2,2-dimethylpropane

### Synthetic Example

A solution was prepared by dissolving 18.25 g of TPE-Q as a diamine in 250 g of DMAc with stirring in a 500-ml separable flask. The solution was cooled in an ice bath and 33.375 g of BP-TME as a tetracarboxylic acid dianhydride was added in a nitrogen atmosphere. The solution was returned to room temperature and allowed to polymerize with continuous stirring for 3 hours to give a viscous polyimide precursor resin solution A.

The polyimide precursor resin solutions B through L were prepared in the same manner as above by the use of the acid dianhydrides and diamines listed in Table 1.

TABLE 1

| Acid dianhydride | | Diamine | | Precursor |
|---|---|---|---|---|
| | Amount | | Amount | resin |
| Kind | used (mol) | Kind | used (mol) | solution |
| BP-TME | 0.0625 | TPE-Q | 0.0625 | A |
| BP-TME | 0.0514 | APB | 0.0600 | B |
| PMDA | 0.0343 | PDA | 0.0257 | |
| BP-TME | 0.0071 | TPE-R | 0.0714 | C |
| BTDA | 0.0643 | | | |
| BPAP-TME | 0.0250 | TPE-R | 0.0556 | D |
| DSDA | 0.0250 | | | |
| PMDA | 0.0056 | | | |
| TMHQ | 0.0800 | TPE-R | 0.0800 | E |
| BPA-TME | 0.0900 | TPE-R | 0.0900 | F |
| Bisc-TME | 0.0700 | TPE-R | 0.0700 | G |
| BPDA | 0.1000 | TPE-R | 0.1000 | H |
| BTDA | 0.1000 | TPE-Q | 0.1000 | I |
| BTDA | 0.1000 | DAPE | 0.1000 | J |
| BPADA | 0.1000 | TPE-R | 0.1000 | K |
| ODPA | 0.1000 | TPE-R | 0.1000 | L |

### Example 1

The polyimide precursor resin solution A obtained in the aforementioned Synthetic Example was applied to an 18 μm-thick copper foil by the use of an applicator to a thickness of 40 μm as cured polyimide, dried at 110° C. for 5 minutes and then subjected to a stepwise heat treatment for 3 minutes each at 130, 160, 200, 250 and 320° C. to form a polyimide resin layer on the copper foil. The rate of etching was determined for the laminate thus obtained by the etching test with an aqueous alkaline solution. The results are shown in Table 2.

### Examples 2-12

The laminates were prepared by the use of the polyimide precursor resin solutions B through L as in Example 1 and tested for the rate of etching. The results are shown in Table 2. It is to be noted that Examples 8-12 are comparative examples.

TABLE 2

| Example | 1 | 2 | 3 | 4 | 5 | 6 | 7 | 8 | 9 | 10 | 11 | 12 |
|---|---|---|---|---|---|---|---|---|---|---|---|---|
| Precursor | A | B | C | D | B | F | G | H | I | J | K | L |
| resin | | | | | | | | | | | | |
| solution | | | | | | | | | | | | |
| Rate of | 7.0 | 9.0 | 7.0 | 12.5 | 9.0 | 8.8 | 5.0 | 0.8 | 0.3 | 0.3 | 0.1 | 0.1 |
| etching | | | | | | | | | | | | |
| (μm/min) | | | | | | | | | | | | |

### Example 13

The polyimide precursor solution D obtained above was applied to an 18 μm-thick copper foil by the use of an applicator to a thickness of 40 μm as cured polyimide, dried at 110° C. for 5 minutes, then subjected to a stepwise heat treatment for 3 minutes each at 130, 160, 200, 250 and 320° C. to effect imidation and further bonded by thermocompression to an 18 μm-thick copper foil with the polyimide resin layer facing the copper foil at 375° C. and 15 MPa to give a double-sided laminate having copper foils on both sides of the polyimide resin layer.

In order to form a circuit pattern of a specified shape having a hole diameter of 50 μm on one side of the laminate thus obtained, a resist layer was provided and the copper foil was etched in the specified shape with the resist layer serving as a mask. Then, the resist layer was removed and the polyimide resin layer was processed by wet etching with the copper foil serving as a mask. This wet etching was performed by the use of a 30 wt % aqueous solution of potassium hydroxide kept at 80° C. to which 11 wt % of ethylenediamine and 22 wt % ethylene glycol had been added as an etching solution. After a lapse of 4 minutes, the substrate was taken out of the etching solution, washed with water to remove the solution adhering to its surface and dried. The aforementioned holes with a diameter of 50 μm were connected to the copper foil as the polyimide resin layer was removed by wet etching. The rate of etching was 10 μm/min or more.

An experiment was carried out separately by substituting the polyimide precursor resin solution J for the polyimide precursor resin solution D. The condition of the polyimide resin layer after a lapse of 4 minutes indicated practically no progress of wet etching.

What is claimed is:

1. A laminate for a substrate of printed wiring board having a metal foil on one or both sides of a polyimide resin layer and processible by wet etching wherein at least one of the aforementioned polyimide resin layer contains 5 mol % or more of a structural unit represented by the following general formula (1) 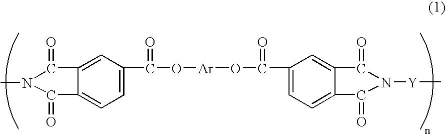
(wherein Ar is a divalent organic group containing one or more aromatic rings, Y is a divalent group remaining after removal of the amino groups from a diamine and n is a number in the range of 1˜1000) and shows a rate of etching of 2.0 μm/min or more by a 30 wt % aqueous solution of potassium hydroxide kept at 80° C. to which 11 wt % of ethylenediamine and 22 wt % of ethylene glycol are added.

2. A laminate for a substrate of printed wiring board as described in claim 1 wherein the polyimide resin layer comprises polyimide resin obtained by the reaction of a diamine with a tetracarboxylic acid dianhydride and 50 mol % or more of said tetracarboxylic acid dianhydride is a trimellitic anhydride ester tetracarboxylic acid dianhydride represented by the following general formula (2) 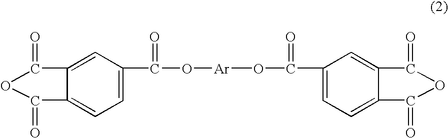
(wherein Ar is a divalent organic group having one or more aromatic rings) or a mixture of said trimellitic anhydride ester tetracarboxylic acid dianhydride and at least one kind of tetracarboxylic acid dianhydride selected from pyromellitic dianhydride, 3,3′,4,4′-benzophenonetetracarboxylic acid dianhydride and 3,3′,4,4′-diphenylsulfonetetracarboxylic acid dianhydride.

3. A laminate for a substrate of printed wiring board as described in claim 1 wherein the laminate is obtained by preparing a metal foil to serve as a conductive layer, applying to the surface of said metal foil a solution of a polyimide precursor resin which is to form the polyimide resin containing 5 mol % or more of a structural unit represented by the following general formula (1) 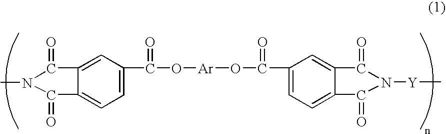
(wherein Ar is a divalent organic group containing one or more aromatic rings, Y is a divalent group remaining after removal of the amino groups from a diamine and n is a number in the range of 1˜1000) to a thickness in the range of 3-75 μm as a cured polyimide layer and performing a heat treatment to effect drying and curing of the polyimide precursor resin.

4. A method for fabricating a substrate of printed wiring board which comprises the following steps;
a) a step for preparing the laminate for a substrate of printed wiring board described in claim 1,
b) a step for forming a circuit pattern on the metal foil of said substrate of printed wiring board,
c) a step for preparing an aqueous alkaline etching solution with a pH in the range of 11-14, and
d) a step for processing by wet etching the exposed area of the polyimide resin layer in the laminate on which said circuit pattern has been formed at a rate of 2.0 μm/min or more by the use of said etching solution.
